(19) United States
(12) Patent Application Publication
(10) Pub. No.: US 2026/0142431 A1
(43) Pub. Date: May 21, 2026

(54) Snap-In Bridge Connector

(71) Applicant: TE Connectivity Solutions GmbH, Schaffhausen (CH)

(72) Inventors: Mohamed ABOULKASSEM, Schaffhausen (CH); Bharath SRIKANTEGOWDA, Schaffhausen (CH); Shridhar VERNEKAR, Schaffhausen (CH); Ravi Molakalmuru RAGHAVENDRA, Schaffhausen (CH)

(73) Assignee: TE Connectivity Solutions GmbH, Schaffhausen (CH)

(21) Appl. No.: 19/390,735

(22) Filed: Nov. 17, 2025

(30) Foreign Application Priority Data
Nov. 20, 2024 (EP) 24214330.3

(51) Int. Cl. H01R 25/16; H01R 4/48; H01R 13/11; H01R 13/627; H01R 43/16

(52) U.S. Cl. CPC H01R 25/168; H01R 4/4844; H01R 4/4848; H01R 4/485; H01R 13/114; H01R 13/6275; H01R 43/16

(57) ABSTRACT

A snap-in bridge connector, comprising a housing having a housing base, multiple side walls and a housing lid with multiple insertion openings, a current rail positioned on an inside of opposing side walls of the housing, a contacting spring array with multiple contacting spring elements and a preloading spring array with multiple preloading spring elements. The contacting spring array has a ridge shape with a connection ridge connecting the multiple contacting spring elements. Each preloading spring element of the multiple preloading spring elements is set up to hold a respective contacting spring element of the multiple contacting spring elements in a preloaded position. Each preloading spring element is set up to be actuated by a wire inserted into the housing via an insertion opening of the housing lid and to release the respective contacting spring element from the preloaded position to contact the inserted wire to the current rail.

### CROSS-REFERENCE TO RELATED APPLICATION

This application claims the benefit of European Patent Application No. 24214330.3 filed on Nov. 20, 2024 in the European Patent Office, which is hereby incorporated by reference in its entirety.

### BACKGROUND OF THE INVENTION

The invention relates to a snap-in bridge connector.

Bridge connectors for electrical contacting are well known from state of the art. Snap-in connectors are also known from state of the art.

### SUMMARY OF THE INVENTION

The objective the current invention is providing an improved snap-in bridge connector.

The objective is solved by the snap-in bridge connector of claim 1. The dependent claims provide favorable embodiments.

According to an aspect a Snap-in bridge connector is provided, comprising a housing having a housing base, multiple side walls and a housing lid with multiple insertion openings, a current rail positioned on an inside of opposing side walls of the housing, a contacting spring array with multiple contacting spring elements and a preloading spring array with multiple preloading spring elements positioned inside the housing respectively, wherein the contacting spring array has a ridge shape with a connection ridge connecting the multiple contacting spring elements, wherein the contacting spring elements are positioned pairwise on opposing sides of the connection ridge, wherein each preloading spring element of the multiple preloading spring elements is set up to hold a respective contacting spring element of the multiple contacting spring elements in a preloaded position, wherein each preloading spring element is set up to be actuated by a wire inserted into the housing via an insertion opening of the housing lid and to release the respective contacting spring element from the preloaded position, wherein the respective contacting spring element released from the preloaded position is set up to contact the inserted wire to the current rail.

This can achieve the technical advantage, that an improved snap-in bridge connector can be provided. The snap-in bridge connector comprises a contacting spring array with multiple contacting spring elements and a preloading spring array with multiple preloading spring elements. Via the multiple preloading spring elements the respective multiple contacting spring elements can be held in preloaded positions. By insertion of wires into the housing the preloading spring elements can be actuated individually and individually release a respective contacting spring elements such that the respective contacting spring element released from the preloaded position can contact the wire inserted into the housing to the current rail positioned inside the housing of the snap-in bridge connector.

This way a contacting of wires using the snap-in mechanism can be realized. The multiple contacting spring elements of the contacting spring array are connected to each other via a connection ridge of the contacting spring array having a ridge-like shape. Thus, the contacting spring array can be manufactured as one piece, which simplifies the manufacturing process. Nevertheless, each of the multiple contacting spring elements is set up to contact one inserted wire individually. Thus, the snap-in bridge connector is set up to provide a contacting of multiple wires using the snap-in mechanism, wherein each wire is connected individually.

Because multiple contacting spring elements are positioned on opposite side of the connection ridge two rows of contacting spring elements are provided by the one contacting spring array. This allows for simultaneous contacting of multiple wires in two parallel contacting rows.

According to an embodiment the connector is set up to connect multiple wires in series at one electrical potential by means of the multiple contacting spring elements of the contacting spring array connected to each other via the connection ridge.

This can achieve the technical advantage, that via the snap-in bridge connector multiple wires can be connected in series at one common electrical potential.

According to an embodiment each contacting spring element comprises a slat-shaped main body with a connection end connected to the connection ridge and a free end, wherein the preloading spring array has a ridge shape with a connection ridge connecting the multiple preloading spring elements, wherein the preloading spring elements are positioned pairwise on opposing sides of the connection ridge, wherein each preloading spring element comprises a slat-shaped main body with a connection end connected to the connection ridge and an actuation end, wherein the actuation end comprises an actuation surface comprising a holding member protruding from the actuation surface, wherein the actuation surface is angled to the slat-shaped main body, wherein the connection ridge of the contacting spring array is positioned on top of the connection ridge of the preloading spring array, wherein the connection ridges of the contacting spring array and of the preloading spring array are positioned adjacent to the housing lid, wherein the contacting spring elements and the preloading spring elements extend from the respective connection ridge in direction of the housing base, wherein the actuation surfaces of the multiple preloading spring elements are spaced apart from the housing base.

This can achieve the technical advantage, that both the contacting spring array and the preloading spring array can be manufactured in one piece. This can simplify the manufacturing process of the entire connector. The overall design of the contacting spring array including the contacting spring elements and the preloading spring array including the preloading spring elements is held as simple as possible, in order to further simplify the manufacturing process and the assembling process of the connector. Even though all contacting elements are connected via the connection ridge and all preloading spring elements are connected via the respective connection ridge respectively, all contacting spring elements and all preloading spring elements can be actuated individually.

According to an embodiment in the preloaded position the free end of at least one contacting spring element is held in the preloaded position by the holding member, wherein in the preloaded position the respective actuation surface is set up to be pushed in direction of the housing base by the wire inserted into the housing via an insertion opening of the housing lid, wherein by the actuation surface being pushed in direction of the housing base the holding member of the respective actuation surface is set up to release the free end of the respective contacting spring element and to release the contacting spring element from the preloaded position, and by being released from the preloaded position and the contacting spring element is set up to contact the inserted wire via the free end and contact the wire against the current rail.

This can achieve the technical advantage that a reliable and easy to execute contacting process via execution of the snap-in mechanism can be provided. For this, the inserted wire actuates the actuation surface of the actuation end of a respective preloading spring element by pushing the actuation surface in direction of the housing base. By this, the actuation surface is elastically deformed and therefore the holding member protruding from the actuation surfaces releases the free end of the contacting spring element, which is then set up to contact the inserted wire to the current rail. This snap-in mechanism for contacting wires is very reliable, fast and easy to execute. And the respective contacting spring array and preloading spring array are easy and cheap to manufacture.

According to an embodiment the connector further comprises multiple pushing members, wherein the pushing members are positioned slidably in multiple pushing openings of the housing lid, wherein in a preloaded position of at least one contacting spring element at least one pushing member is positioned inserted into the housing and in contact with the at least one contacting spring element in the preloaded position, wherein by the respective contacting spring element being released from the preloaded position the at least one pushing member is set to be pushed at least partially out of the housing by the contacting spring element, and/or wherein by being positioned at least partially protruding from the pushing opening of the housing lid the pushing member is set to be pushed into the housing and by this to push the respective contacting spring element into the preloaded position.

This can achieve the technical advantage, that via the multiple pushing members, one the contacting of the wire can be shown to the user, such that the user automatically knows when the wire is contacted, and second the pushing member can be used to reset the respective contacting spring element into the preloaded position and by this release the inserted wire. When the contacting spring element is released from the preloaded position and contacts an inserted wire to the current rail the respective pushing member is pushed at least partially out of the housing by the released contacting spring element.

As the pushing member is pushed partially out of the housing, the user can identify the movement of the pushing member and interpret this with the release of the contacting spring element and the contacting of the wire. In addition to the movement of the pushing member in additional audible signal, for example a click noise, can be produced in order to further signal the user the successful contacting of the wire.

By pushing the respective pushing member back into the housing, the pushing member contacts the respective released contacting spring element and pushes the released contacting spring element back into the preloaded position. This releases the wire, which can be removed from the connector and resets the connector into the preloaded position.

According to an embodiment the pushing members each have a rod-like shape with a slanted end for contacting the respective contacting spring elements.

This can achieve the technical advantage, that the rod-like shape allows an easy to manufacture pushing member and the slanted end allows for a better contacting of the respective contacting spring element in order to reset the contacting spring element into the preloaded position.

According to an embodiment the housing base comprises at least one footing structure with at least one pedestal structure positioned on top of the footing structure, and wherein the actuation surface of at least two preloading spring elements positioned on opposing sides of the connection ridge of the preloading spring array are positioned partially on the footing structure on opposing sides of the pedestal structure.

This can achieve the technical advantage, that via the footing structure and the pedestal structure, on which the actuation surfaces of the preloading spring elements are positioned a distance between the actuation surfaces of the preloading spring elements and the housing base of the housing is achieved.

This allows the actuation surface to be elastically bend in direction of the housing base by the inserted wire, which leads to a release of the free end of the respective contacting spring element and the release of the contacting spring element from the preloaded position.

Thus, the footing structure and the pedestal structure allow for the simple design of the preloading spring elements of the preloading spring array and thus for the simplified manufacturing process. The footing structure and the pedestal structure further lead to a stable positioning of the preloading spring array inside the housing and avoid movement of the preloading spring array inside the housing.

According to an embodiment the housing base comprises multiple separation walls, wherein each separation wall comprises a support protrusion protruding in direction of the housing lid, wherein the connected connection ridges of the contacting spring array and the preloading spring array are position on top of the multiple support protrusions, and wherein the multiple separation walls separate pairs of contacting spring elements and preloading spring elements.

This can achieve the technical advantage, that the separation walls further improve the stable positioning of the contacting spring array and the preloading spring array inside the housing. The support protrusions further improve the assembling process of the connector.

According to an embodiment the contacting spring array and the preloading spring array are connected to each other by means of a latching connection with latching elements formed on the connection ridges of the contacting spring array and the preloading spring array.

This can achieve the technical advantage, that via the latching connecting a robust and easy to execute connection of the contacting spring array and the preloading spring array is achieved. The connection of the contacting spring array and the preloading spring array further lead to a more robust connector.

According to an embodiment the holding members are formed as bending elements formed from the respective actuation surface via punching processes.

This can achieve the technical advantage that the holding elements are technically simple and easy to manufacture.

According to an embodiment the slat-shaped main bodies of the contacting spring elements each comprise a bending point with the free end being angled to the main body.

This can achieve the technical advantage, that via the angle between the free end and the slat-shaped main bodies of the contacting spring elements a better connection and contacting of the wires via the free end of the contacting spring elements can be achieved. The angle between the free end and the slat-shaped main bodies leads to a more robust contacting spring element and a higher spring force. This leads to a better connectivity.

According to an embodiment the free end comprises a widened contacting portion.

This can achieve the technical advantage, that the widened contacting portion leads to a wider contacting part of the free end of the contacting spring element and the respective wire, this leads to a better electrical contacting.

According to an embodiment the current rail has a slit u-profile shape with a base face and two side faces comprising multiple slits, and wherein the two side faces are aligned to two opposing side walls of the housing.

This can achieve the technical advantage, that via the u-profile shape the current rail can be manufactured in one piece, which simplifies the manufacturing process. Via the u-profile the current rail further can be positioned on both side walls of the housing and therefore can be used for contacting wires in both contacting rows.

According to an embodiment the contacting spring array is formed in one piece by means of a punching process and a bending process, and/or wherein the preloading spring array is formed in one piece by means of a punching process and a bending process, and/or wherein the current rail is manufactured in one piece by means of a punching process and a bending process.

This can achieve the technical advantage, that an easy and cheap manufacturing process of the contacting spring array, the preloading spring array and the current rail can be provided.

According to an embodiment the contacting spring array and/or the preloading spring array and/or the current rail are connected to the housing by means of a latching connection.

This can achieve the technical advantage, that the contacting spring array and/or preloading spring array and/or current rail are securely fixed to the housing and therefore robustly positioned inside the connector housing.

According to an embodiment the connector is set to contact stranded wires and/or solid wires and/or ferrule wires.

This can achieve the technical advantage, that the current connector can be used for contacting multiple different types of wires.

According to an embodiment the housing and the pushing members are manufactured out of an insulating material, and/or wherein the contacting spring array, the preloading spring array and the current rail are manufacture out of an electrically conductive material.

This can achieve the technical advantage that a secure snap-in bridge connector can be provided.

According to an embodiment the insertion openings are arranged in two parallel rows, and wherein each of the insertion openings is aligned with one actuation surface of one preloading spring element.

This can achieve the technical advantage that multiple wires can be contacted in two parallel contacting rows.

### BRIEF DESCRIPTION OF THE DRAWINGS

The invention is explained below in more detail with reference to the figures. It shows:

FIG. 1 is a perspective schematic sectional view of snap-in bridge connector according to an embodiment;

FIG. 2 is a frontal schematic sectional view of the snap-in bridge connector of FIG. 1;

FIG. 3A is a perspective schematic views of a contacting spring array of the snap-in bridge connector according to an embodiment;

FIG. 3B is a perspective schematic views of a preloading spring array of the snap-in bridge connector according to an embodiment;

FIG. 4 is a perspective schematic view of the contacting spring array and the preloading spring array of the snap-in bridge connector according to an embodiment;

FIG. 5 is a perspective schematic explosion illustration of the snap-in bridge connector according to an embodiment;

FIG. 6A is a frontal schematic sectional view of the snap-in bridge connector in a first state of contacting a wire according to an embodiment;

FIG. 6B is a frontal schematic sectional view of the snap-in bridge connector in a second state of contacting a wire according to an embodiment;

FIG. 6C is a frontal schematic sectional view of the snap-in bridge connector in a third state of contacting a wire according to an embodiment;

FIG. 7A is a frontal schematic sectional views of the snap-in bridge connector in fourth states of contacting a wire according to an embodiment;

FIG. 7B is a frontal schematic sectional views of the snap-in bridge connector in fifth states of contacting a wire according to an embodiment; and

FIG. 7C is a frontal schematic sectional views of the snap-in bridge connector in sixth states of contacting a wire according to an embodiment.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

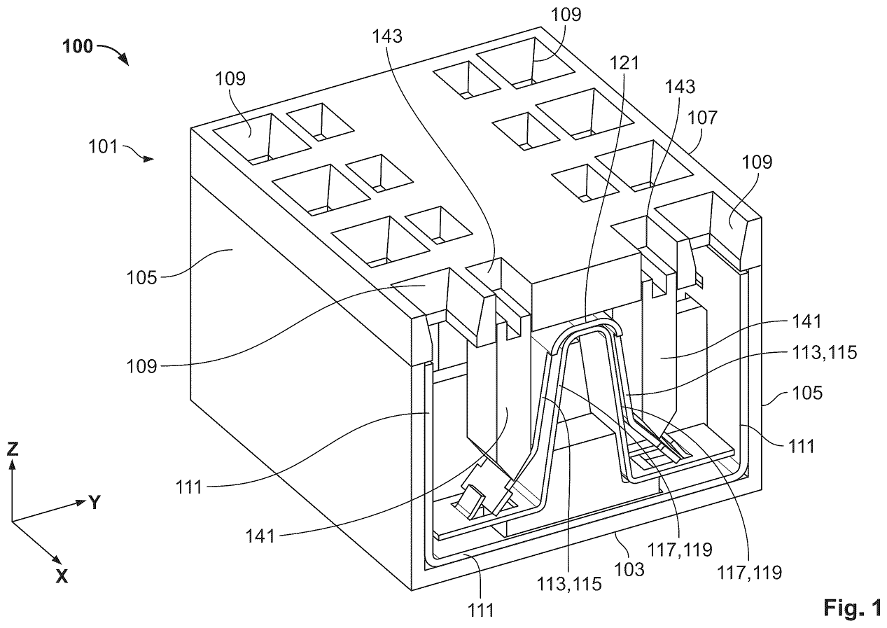

FIG. 1 shows a perspective schematic sectional view of snap-in bridge connector 100 according to an embodiment.

The snap-in bridge connector 100 comprises a housing 101 with a housing base 103, at least two side walls 105 and a housing lid 107. The housing lid comprises multiple insertion openings 109 for inserting to be contacted wires 200, not shown in FIG. 1.

The connector 100 further comprises a current rail 111 arranged inside the housing 101. The connector 100 further comprises a contacting spring array 113 with multiple contacting spring elements 115 and a preloading spring array 117 comprising multiple preloading spring elements 119.

The contacting spring array 113 has a ridge-like shape comprising a connection ridge 121 connecting the multiple contacting spring elements 115. The multiple contacting spring elements 115 are hereby positioned pairwise on opposing sides of the contacting ridge 121.

In FIG. 1 each of the multiple contacting spring elements 115 is held by one preloading spring element 119 in a preloaded position, respectively.

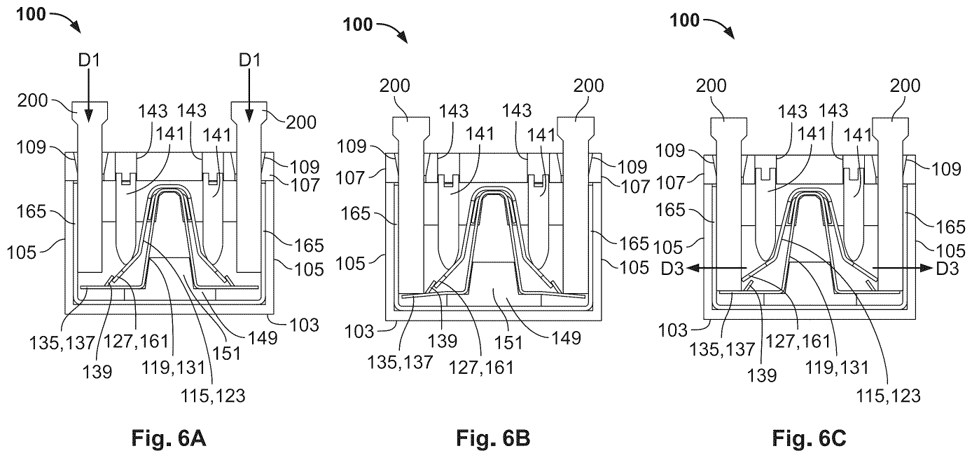

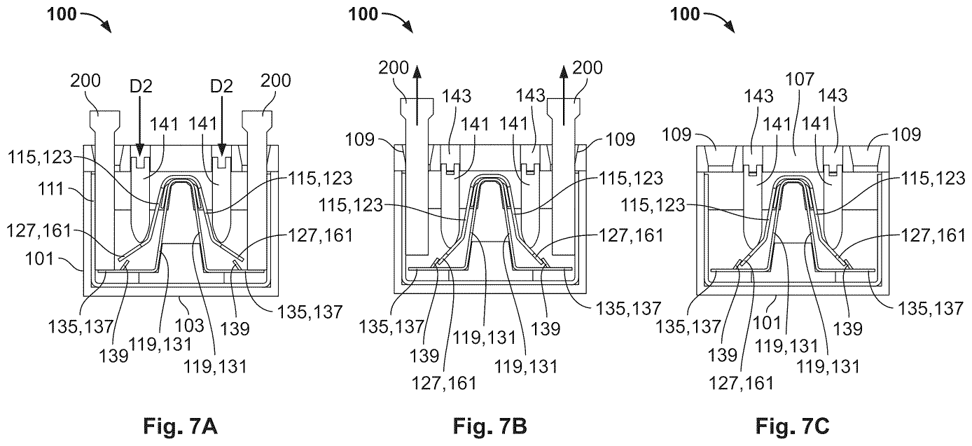

Each of the preloading spring elements 119 can be actuated by a wire 200 inserted into the inside of the housing 101. By actuation of the preloading spring element 119 the respective contacting spring element 115 is released from the preloaded position and is capable of contacting the inserted wire 200 to the current rail 111. For a more precise description of the snap-in mechanism for contacting wires 200 please refer to the specification related to FIGS. 6 and 7.

In the shown embodiment the connector 100 further comprises multiple pushing members 141. The pushing members 141 are positioned in pushing openings 143 of the housing lid 107. Each pushing member 141 contacts a respective contacting spring element 115. The pushing member 141 can be used to signal a successful contacting of an inserted wire 200 and/or to reset a released contacting spring element 115 into the preloaded position. For more precise description of the functionality of the pushing member 141 please refer to the specification related to FIGS. 6 and 7.

In the shown embodiment the insertion openings 109 are positioned in two parallel contacting rows. Each insertion opening 109 corresponds to a position of a respective contacting spring element 115 and an associated preloading spring element 119 inside the housing 101. This allows for contacting of multiple wires 200 simultaneously in two parallel contacting rows.

Each insertion opening 109 is positioned in the housing lid 107 aligned with one actuation surface 137 of one preloading spring element 119. By inserting a wire 200 through the respective insertion opening 109 exactly one actuation surface 137 of one preloading spring element 119 can be actuated and the inserted wire 200 can be contacted by exactly one contacting spring element 115.

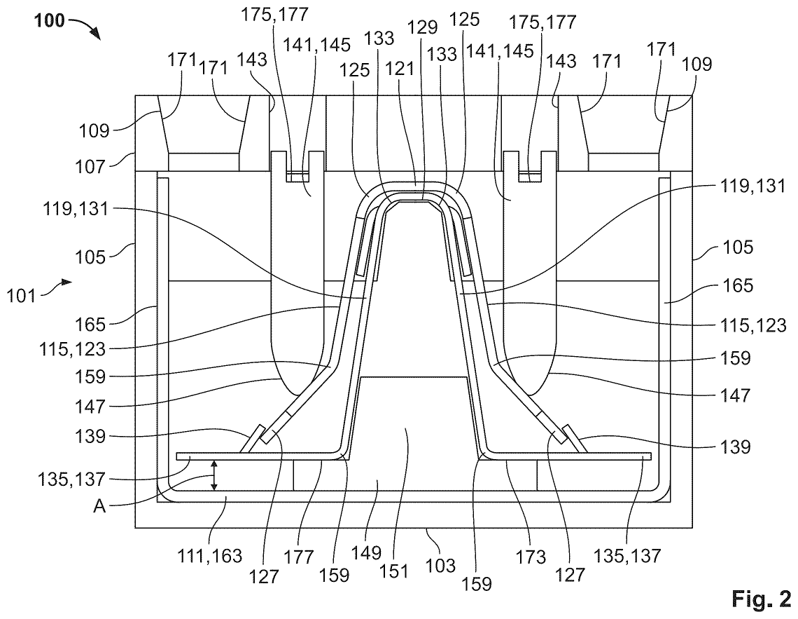

FIG. 2 shows a frontal schematic sectional view of the snap-in bridge connector 100 of FIG. 1.

FIG. 2 clearly illustrated the ridge-like shape of the contacting spring array 113. In FIG. 2 two contacting spring elements 115 that are positioned on opposing sides of the connection ridge 121 of the contacting spring array 113 are shown. In the shown embodiment each of the contacting spring elements 115 comprises a slat-shaped main body 123 having a connection end 125 connected to the connection ridge 121 and a free end 127.

In the shown embodiment the slat-shaped main body 123 further comprises a bending point 159. As a result, the free end 127 has an angle to the slat-shaped main body 123 of the respective contacting spring element 115.

In the shown embodiment the preloading spring array 117 also has a ridge shape comprising a connection ridge 129 connecting the multiple preloading spring elements 119. In FIG. 2 two preloading elements 119 are shown positioned on opposing sides of the connection ridge 129, respectively. In the shown embodiment each preloading spring element 119 also has a slat-shaped main body 113 comprising a connection end 133 connected to the connection ridge 129 and an actuation end 135. The actuation end 135 comprises an actuation surface 137. The slat-shaped main body 131 also comprises a bending point 159, such that the actuation end 135 and in particular the actuation surface 137 is angled to the slat-shaped main body 131.

In the shown embodiment, the contacting spring array 113 is positioned on top of the preloading spring array 117, such that the connection ridge 121 of the contacting spring array 113 is positioned on top of the connection ridge 129 of the preloading spring array 117.

Both connection ridges 121, 129 of the contacting spring array 113 and the preloading spring array 117 are positioned adjacent to the housing lid 107, wherein the multiple contacting spring elements 115 and preloading spring elements 119 extend in direction towards the housing base 103.

In the shown embodiment the actuation surfaces 137 of the actuation ends 135 of the preloading spring elements 119 are oriented mostly parallel to the housing base 103. This leaves the preloading spring array 117 with a mostly trapezoidal cross section.

In the shown embodiment each of the actuation surfaces 137 comprises a holding member 139 protruding from the respective actuation surface 137. The holding member 139 contacts the free end 127 of the respective contacting spring element 115 and by this holds the contacting spring element 115 in the preloaded position.

In the preloaded position the respective contacting spring elements 115 are in a bend position and therefore generate a restoring force.

In the shown embodiment the housing 101 further comprises a footing structure 149 with a pedestal structure 151 positioned on top of the footing structure 149. The footing structure 149 is positioned center on the housing base 103. The footing structure 149 comprises two positioning faces 173 placed on opposing sides of the pedestal structure 151. The two shown actuation surfaces 137 of the two shown preloading spring elements 119 are positioned partially on the two positioning faces 173 and extend beyond the footing structure 149. This results in a distance A between the actuation surface 137 and the housing base 103. This distance A leaves room for actuation of the actuation surface 137 by means of bending the actuation surface 137 in direction towards the housing base 103 in order to release the free end 127 from the holding member 139 and therefore release the respective contacting spring element 115 from the preloaded position.

In the shown embodiment the current rail 111 comprises a u-shaped profile with two opposing side faces 165 and a base face 163. The base face 163 is positioned on the housing base 103 whereas the two opposing side faces 165 are positioned on opposing side walls 105 of the housing 101.

FIG. 2 further shows two pushing members 141. Each pushing member 141 is positioned in a respective pushing opening 143 of the housing lid 107 and contacts one contacting spring element 115. Each pushing member comprises a rod-shaped main body 145 with a slanted end 147. The slanted end 147 contacts the respective contacting spring element 115. Opposing to the slanted end 147 the pushing member 141 further comprises a pushing end 175 with a pushing slit 177. The pushing end 175 can be used to push the pushing member 141 into the inside of the housing 101 in order to reset the connector 100, as described with regard to FIG. 7. Via the pushing slit 177 the pushing member 141 can be actuated using a screw driver for example.

In FIG. 2 further two insertion openings 109 arranged in the housing lid 107 for inserting wires 200 into the inside of the connector 100 are illustrated. The insertion openings 109 are positioned between the pushing openings 143 and the side of the housing 101 and are positioned directly adjacent to the side faces 165 of the current rail 111.

In the shown embodiment the insertion openings 109 comprise slanted faces 171. The slanted faces 171 allow for an easier insertion of a to be connected wire 200 into the insertion opening 109 and by this into the inside of the connector 100.

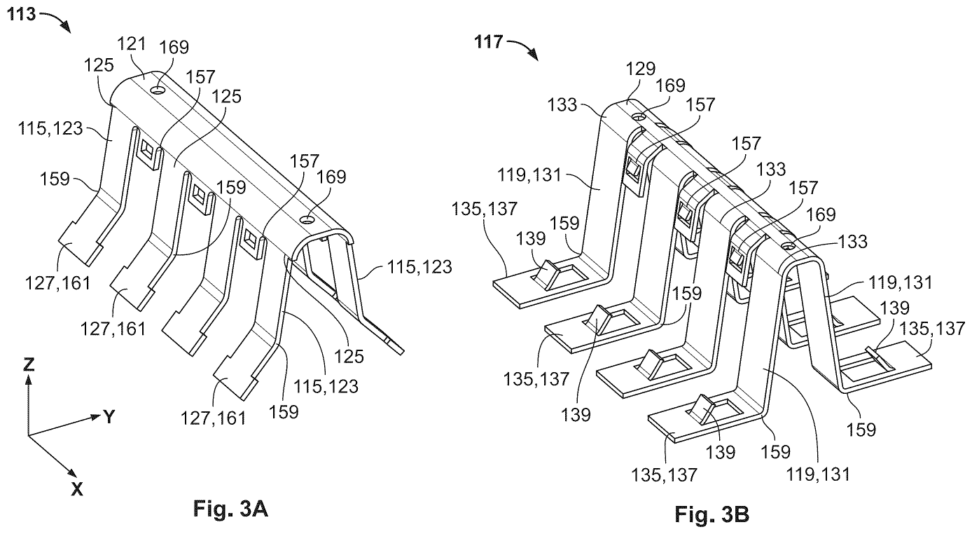

FIGS. 3A, 3B show perspective schematic views of a contacting spring array 113 and a preloading spring array 117 of the snap-in bridge connector 100 according to an embodiment.

FIG. 3A shows a perspective view of one contacting spring array 113 with multiple contacting spring elements 115. In the current embodiment the contacting spring array 113 comprises eight contacting spring elements 115 divided in two groups of four contacting spring elements 115 positioned on opposing sides of the connection ridge 121.

Each contacting spring element 115 comprises a slat-shaped main body 123 with a connection end 125 connected to the connection ridge 121 and a free end 127. The free end 127 is angled relative to the slat-shaped main body 123 via a bending point 159.

In the shown embodiment each free end 127 comprises a contacting portion 161. The contacting portion 161 is designed with a widened width with respect to the width of the slat-shaped main body 123. The widened contacting portion 161 allows for a better contacting of a respective wire 200.

In the shown embodiment the contacting spring array 113 further comprises multiple latching elements 157. In the shown embodiment the latching element 157 are arranged at the connection ridge 121 and are positioned between adjacent contacting spring elements 115. In FIG. 2 only three latching elements 157 positioned on one side of the connection ridge 121 are illustrated. According to another embodiment however an additional number of latching elements 157 can be arranged on the other side of the connection ridge 121, not shown in the illustrated perspective.

In the shown embodiment the connection ridge 121 further comprises two positioning dimples 169.

FIG. 3B shows a preloading spring array 117 with multiple preloading spring elements 119. The preloading spring array 117 comprises a connection ridge 129 with the multiple preloading spring element 119 being positioned on opposing sides of the connection ridge 129.

Each preloading spring element 119 comprises a slat-shaped main body 131 with a connection end 133 connected to the connection ridge 129 and an actuation end 135 comprising an actuation surface 137. The actuation surface 137 is angled to the slat-shaped main body 131 via a bending point 159.

In the shown embodiment each actuation surface 137 comprises one holding member 139 protruding from the actuation surface 137.

In the shown embodiment the holding member 139 is built as a bending element formed from the respective actuation surface 137 via bending and punching processes.

In the shown embodiment the preloading spring array 117 comprises eight preloading spring elements 119 arranged in two groups of four preloading spring elements 119 positioned on opposing sides of the connection ridge 129.

The preloading spring array 117 is therefore designed to match the design of the contacting spring array 113 such that each contacting spring element 115 can be held by one preloading spring element 119 in the preloaded position.

In the shown embodiment the preloading spring array 117 further comprises multiple latching elements 157. In FIGS. 3A, 3B three latching elements 157 connected to the connection ridge 129 and positioned between the spaced preloading spring elements 119 are shown. Alternative to this embodiment however on the other side of the connection ridge 129, not visible from the shown perspective, an additional number of latching elements 157 can be arranged.

The connection ridge 129 further comprises two positioning dimples 169, analogous to the connection ridge 121 of the contacting spring array 113.

By positioning the contacting spring array 113 on top of the preloading spring array 117 by placing the connection ridge 121 of the contacting spring array 113 on top of the connection ridge 129 of the preloading spring array 117 the contacting spring array 113 and the preloading spring 117 can be connected to each other by means of a latching connection executed by the shown latching elements 157.

The positioning dimples 169 can hereby be used to position the connection ridge 121 of the contacting spring array 113 on top of the connection ridge 129 of the preloading spring array 117.

As shown in the current embodiment, the contacting spring array 113 is manufactured in one piece. Analogously the preloading spring array 117 is manufactured in one piece as well. The contacting spring array 113 and the preloading spring array 117 can therefore be manufactured by means of a punching process and a bending process, respectively.

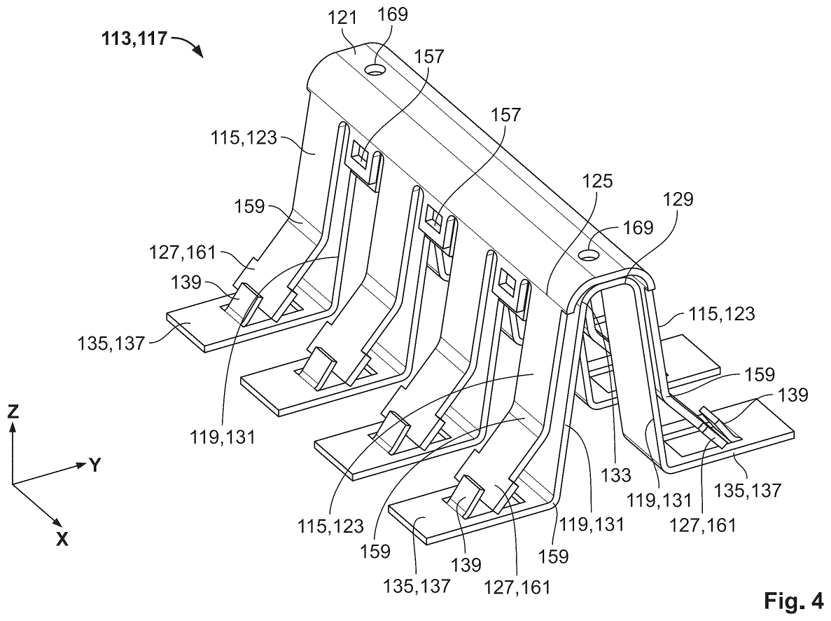

FIG. 4 shows another perspective schematic view of a contacting spring array 113 and a preloading spring array 117 of the snap-in bridge connector 100 according to an embodiment.

FIG. 4 illustrates the contacting spring array 113 positioned on top of the preloading spring array 117 of FIG. 3. The contacting spring array 113 and the preloading spring array 117 are connected to each other via the latching elements 157.

As illustrated in FIG. 4, by positioning the contacting spring array 113 on top of the preloading spring array 117 each contacting spring element 115 is placed directly on top of a respective preloading spring element 119.

In FIG. 4 the contacting spring array 113 is shown in a preloaded position. For this, every contacting spring element 115 is held by the holding member 139 of the actuation surface 137 of the respective preloading spring element 119 and therefore the respective contacting spring element 115 is held in the preloaded position.

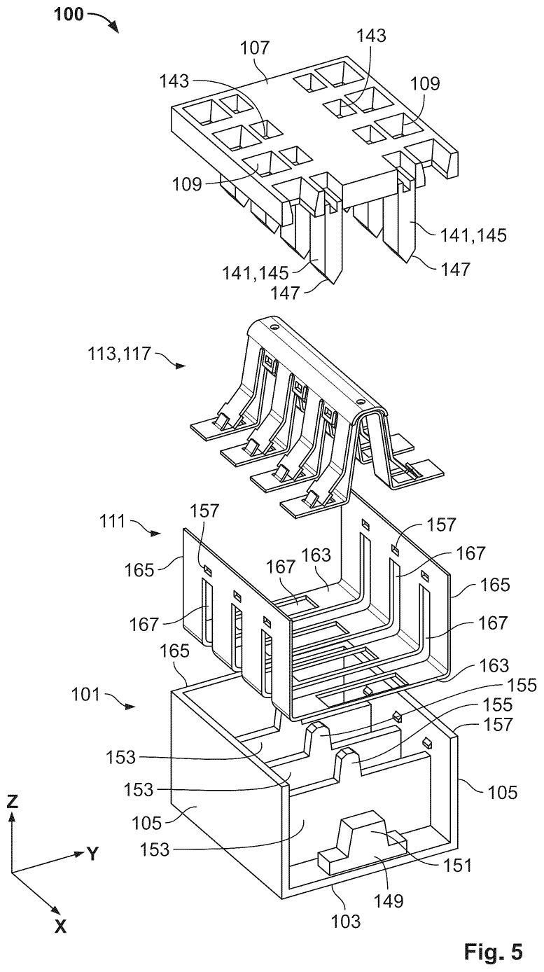

FIG. 5 shows a perspective schematic explosion illustration of the snap-in bridge connector 100 according to an embodiment.

FIG. 5 shows that the connector 100 comprises multiple pushing members 141. In the current embodiment the connector 100 comprises eight pushing members 141 arranged in two groups of four. In the shown embodiment one pushing member 141 per contacting spring element 115 is provided, such that each of the eight contacting spring elements 115 can be reset individually by a respective pushing member 141.

In the shown embodiment it is also illustrated that the current rail 111 has a u-shaped profile with a base face 163 and two parallel side faces 165. The current rail 111 further comprises multiple slits 167. The current rail 111 further has multiple latching elements 157 for providing a latching connection to the housing 101.

In the shown embodiment the housing comprises multiple separation walls 153. The separation walls 153 are aligned connecting two side walls 105 of the housing 101. In the shown embodiment the housing 101 comprises three separation walls 153.

When positioned in the housing 101 each of the four pairs of contacting spring elements 115 and four pairs of preloading spring elements 119 are separated by a separation wall 153.

In the shown embodiment each of the separation walls 153 further comprises a support protrusion 155. Each support protrusion 155 is positioned on top of a respective separation wall 153.

When positioned in the housing 101 the connection ridges 121, 129 of the contacting spring array 113 and the preloading spring array 117 are supported by the supporting protrusions 155.

In the shown embodiment the housing further comprises multiple latching elements 157 arranged on the side walls 105 for providing the latching connection of the housing 101 and the current rail 111.

According to an embodiment the housing 101 including the pushing members 141 is made of an insulating material such as a plastic material.

According to an embodiment the contacting spring array 113, the preloading spring array 117 and the current rail 111 are made of a metal material.

According to an embodiment the contacting spring array 113 and/or the preloading spring array 117 and/or the current rail 111 are made in one piece by means of a bending process and punching process.

In the shown embodiment the contacting spring array 113 comprises eight contacting spring elements 115, the preloading spring array 117 comprises eight preloading spring elements 119 and the housing lid 107 comprises eight insertion openings 109 and eight pushing openings 143 with eight pushing members 141. This means that according to this embodiment a maximum of eight wires 200 can be contacted simultaneously.

Deviating from this shown embodiment the connector can also be designed with a higher or lower number of contacting spring elements 115, preloading spring elements 119, insertion openings 109 and pushing openings 143 with pushing members 141 in order to provide a simultaneous contacting of a number of wires 200 higher or lower than the number eight shown in the embodiments. The shown embodiments shall not limit the scope of the current invention.

FIGS. 6A, 6B, 6C show frontal schematic sectional views of the snap-in bridge connector 100 in three states of contacting a wire 200 according to an embodiment.

FIGS. 6A, 6B, 6C show different phases of the contacting of a wire 200 by the current connector 100.

FIG. 6A shows the connector 100 in a preloaded position, in which the shown contacting spring elements 115 are held by the respective holding members 139 of the respective preloading spring elements 119 in the preloaded position.

In FIG. 6A two wires 200 are inserted into the connector 100 via two insertion openings 109 of the housing lid 107 along an insertion direction D1.

FIG. 6B shows that when proceeding the insertion along the insertion direction D1 from the position in FIG. 6A the wires 200 eventually contact the actuation surfaces 137 of the respective preloading spring elements 119. In FIG. 6B the situation is shown that the insertion of the wires 200 along the insertion direction D1 has been proceeded to the point that in elastic deformation of the two actuation surfaces 137 of the two preloading spring elements 119 is achieved, in which the actuation ends 135 are bent in direction of the housing base 103. Due to the elastic deformation of the actuation ends 135 in direction of the housing base 103 the holding members 139 of the respective actuation surfaces 137 are slightly moved away from the respective free end 127 of the contacting spring elements 115.

Between FIGS. 6A, 6B the insertion in insertion direction D1 of the two wires 200 has been continued, such that in FIG. 6C due to the elastic deformation of the actuation ends 135 of the two preloading spring elements 119 has led to a complete separation of the two holding members 139 and the respective free ends 127 of the two contacting spring elements 115. As a result, the two contacting spring elements 115 are released from the preloaded position and the two free ends 127, comprising the contacting portions 161 of the two contacting spring elements 115 are accelerated in a contacting direction D3 oriented in direction of the nearest side face 165 of the current rail 111. The acceleration of the contacting portions 161 of the free ends 127 of the released contacting spring elements 115 in contacting direction D3 driven by the restoring force of the respective contacting spring elements 115 the contacting portions 161 of the respective contacting spring elements 115 contact the respective wires 200 and press the wires 200 against the respective side faces 165 of the current rail. This leads to the contacting of the two inserted wires 200.

Due to the movement of the released contacting spring elements 115 the two shown pushing members 141 contacting the respective contacting spring elements 115 are pushed by the released contacting spring elements 115 in direction opposite to the insertion direction D1 and are moved at least partially out of the housing 101. This pushing of the pushing members 141 at least partially out of the housing 101 can be seen as a visual sign to a user of the connector 100 to signal the user the successful contacting of the inserted wires 200. The pushing of the pushing members 141 at least partially out of the housing 101 can be accompanied by an audible signal, for example a clicking noise. This can also be used to signal the user the successful contacting of the wires 200.

FIGS. 7A, 7B, 7C show further frontal schematic sectional views of the snap-in bridge connector 100 in three states of contacting a wire 200 according to an embodiment.

The FIGS. 7A, 7B, 7C show the removal of the two contacted wires 200 from the connector 100 and the resetting of the connector 100 in the preloaded position.

To release the wires 200 from the contacted position the two shown pushing members 141 are pushed inside the housing 101 along a release direction D2. By pushing the pushing members D2 along the release direction D2 further inside the housing 101 the contacting spring elements 115 are also pushed in direction of the housing base 103. This leads to a separation of the contacting portions 161 of the free ends 127 of the respective contacting spring elements 115 from the contacted wires 200.

As the pushing members 141 are further pushed into the housing 101 along the release direction D2 the contacting portions 161 of the free ends 127 of the contacting spring elements 115 are further separated from the wires 200 and are finally pushed into the preloaded position, in which each free end 127 is held by a holding member 139 of the respective actuation surface 137 of the respective preloading spring element 119. As shown in FIG. 7B the wires 200 are now completely separated from the contacting spring elements 115 and can be removed from the connector 100 by pulling the wires 200 out of the housing 101.

As shown in FIG. 7C the connector 100 is now reset into the preloaded position and can be used for further contacting of other wires 200.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A snap-in bridge connector comprising a housing having a housing base, multiple side walls and a housing lid with multiple insertion openings, a current rail positioned on an inside of opposing side walls of the housing, a contacting spring array with multiple contacting spring elements and a preloading spring array with multiple preloading spring elements positioned inside the housing respectively, wherein the contacting spring array has a ridge shape with a connection ridge connecting the multiple contacting spring elements, wherein the contacting spring elements are positioned pairwise on opposing sides of the connection ridge, wherein each preloading spring element of the multiple preloading spring elements is set up to hold a respective contacting spring element of the multiple contacting spring elements in a preloaded position, wherein each preloading spring element is set up to be actuated by a wire inserted into the housing via an insertion opening of the housing lid and to release the respective contacting spring element from the preloaded position, wherein the respective contacting spring element released from the preloaded position is set up to contact the inserted wire to the current rail.

2. The connector of claim 1, wherein the connector is set up to connect multiple wires in series at one electrical potential by means of the multiple contacting spring elements of the contacting spring array connected to each other via the connection ridge.

3. The connector of claim 1, wherein each contacting spring element comprises a slat-shaped main body with a connection end connected to the connection ridge and a free end, wherein the preloading spring array has a ridge shape with a connection ridge connecting the multiple preloading spring elements, wherein the preloading spring elements are positioned pairwise on opposing sides of the connection ridge, wherein each preloading spring element comprises a slat-shaped main body with a connection end connected to the connection ridge and an actuation end, wherein the actuation end comprises an actuation surface comprising a holding member protruding from the actuation surface, wherein the actuation surface is angled to the slat-shaped main body, wherein the connection ridge of the contacting spring array is positioned on top of the connection ridge of the preloading spring array, wherein the connection ridges of the contacting spring array and of the preloading spring array are positioned adjacent to the housing lid, wherein the contacting spring elements and the preloading spring elements extend from the respective connection ridge in direction of the housing base, wherein the actuation surfaces of the multiple preloading spring elements are spaced apart from the housing base.

4. The connector of claim 3, wherein in the preloaded position the free end of at least one contacting spring element is held in the preloaded position by the holding member, wherein in the preloaded position the respective actuation surface is set up to be pushed in direction of the housing base by the wire inserted into the housing via an insertion opening of the housing lid, wherein by the actuation surface being pushed in direction of the housing base the holding member of the respective actuation surface is set up to release the free end of the respective contacting spring element and to release the contacting spring element from the preloaded position, and by being released from the preloaded position and the contacting spring element is set up to contact the inserted wire via the free end and contact the wire against the current rail.

5. The connector of claim 1, further comprising multiple pushing members, wherein the pushing members are positioned slidably in multiple pushing openings of the housing lid, wherein in a preloaded position of at least one contacting spring element at least one pushing member is positioned inserted into the housing and in contact with the at least one contacting spring element in the preloaded position, wherein by the respective contacting spring element being released from the preloaded position the at least one pushing member is set to be pushed at least partially out of the housing by the contacting spring element, and/or wherein by being positioned at least partially protruding from the pushing opening of the housing lid the pushing member is set to be pushed into the housing and by this to push the respective contacting spring element into the preloaded position.

6. The connector of claim 5, wherein the pushing members each have a rod-like shaped main body with a slanted end for contacting the respective contacting spring elements.

7. The connector of claim 3, wherein the housing base comprises at least one footing structure with at least one pedestal structure positioned on top of the footing structure, and wherein the actuation surface of at least two preloading spring elements positioned on opposing sides of the connection ridge of the preloading spring array are positioned partially on the footing structure on opposing sides of the pedestal structure.

8. The connector of claim 3, wherein the housing base comprises multiple separation walls, wherein each separation wall comprises a support protrusion protruding in direction of the housing lid, wherein the connected connection ridges of the contacting spring array and the preloading spring array are positioned on top of the multiple support protrusions, and wherein the multiple separation walls separate pairs of contacting spring elements and preloading spring elements.

9. The connector of claim 1, wherein the contacting spring array and the preloading spring array are connected to each other by means of a latching connection with latching elements formed on the connection ridges of the contacting spring array and the preloading spring array.

10. The connector of claim 3, wherein the holding members are formed as bending elements formed from the respective actuation surface via punching processes.

11. The connector of claim 3, wherein the slat-shaped main bodies of the contacting spring elements each comprise a bending point with the free end being angled to the main body.

12. The connector of claim 11, wherein the free end comprises a widened contacting portion.

13. The connector of claim 1, wherein the current rail has a slit u-profile shape with a base face and two side faces comprising multiple slits, and wherein the two side faces are aligned to two opposing side walls of the housing.

14. The connector of claim 1, wherein the contacting spring array is formed in one piece by means of a punching process and a bending process, and/or wherein the preloading spring array is formed in one piece by means of a punching process and a bending process, and/or wherein the current rail is manufactured in one piece by means of a punching process and a bending process, and/or wherein the contacting spring array and/or the preloading spring array and/or the current rail are connected to the housing by means of a latching connection, and/or wherein the connector is set to contact stranded wires and/or solid wires and/or ferrule wires.

15. The connector of claim 1, wherein the housing and the pushing members are manufactured out of an insulating material, and/or wherein the contacting spring array, the preloading spring array and the current rail are manufacture out of an electrically conductive material, and/or wherein the insertion openings are arranged in two parallel rows, and wherein each of the insertion openings is aligned with one actuation surface of one preloading spring element.
